(19) United States
(12) Patent Application Publication
(10) Pub. No.: US 2026/0245345 A1
(43) Pub. Date: Aug. 20, 2026

(54) PSEUDO DEFECT IMAGE GENERATION DEVICE

(71) Applicant: Hitachi Astemo, Ltd., Hitachinaka-shi, Ibaraki (JP)

(72) Inventors: Naoki HOSOYA, Tokyo (JP); Takahiro FUJIOKA, Hitachinaka-shi, Ibaraki (JP)

(73) Assignee: Hitachi Astemo, Ltd., Hitachinaka-shi, Ibaraki (JP)

(21) Appl. No.: 18/872,191

(22) PCT Filed: May 11, 2023
(86) PCT No.: PCT/JP2023/017657

§ 371 Date: Dec. 5, 2024

(30) Foreign Application Priority Data
Jun. 10, 2022 (JP) 2022-094217

(51) Int. Cl. G06V 10/774; G06T 7/00

(52) U.S. Cl. CPC G06V 10/774; G06T 7/0004

(57) ABSTRACT

A pseudo defect image generation device is provided in which, when a visual inspection using machine learning targeting a processed product is performed, an image of a defective part is shared between product types, and an effort of collecting images of defective parts can be reduced. The pseudo defect image generation device that generates a pseudo defect image to be learned by a learning device includes: a defect library that stores a defective part image; a defect arrangement rule that specifies, based on management information in which a processing item and a permissible processing content are associated with each other, a defect and an inspection region in accordance with the processing item; and a pseudo defect image generation unit that generates a pseudo defect image by arranging the defective part image in the inspection region on a normal product image based on the defect arrangement rule.

### TECHNICAL FIELD

The present invention relates to a pseudo defect image generation device that provides a pseudo defect image for machine learning to a learning device that generates a determiner for visual inspection.

### BACKGROUND ART

When machine learning needs to be applied to a processed product having a predetermined specification, many defective product images and normal product images of the processed product having the same specification are first subjected to machine learning to generate a determiner. When an inspection accuracy of the determiner needs to be improved, the defective product images that are about the same in number as normal product images need to be subjected to machine learning. However, in general, the number of defective products is much smaller than that of normal products. Thus, it is difficult to provide defective product images that are about the same in number as normal product images.

Then, various methods have been proposed to compensate for lack of defective product images. For example, the abstract of Patent Literature 1 discloses a learning data generation device “including: a defective part data storage unit that stores defective part data that are image data of defective part images; a normal product data storage unit that stores normal product data that are image data of normal product images; a learning data generation unit that generates learning data that are image data of learning images in which the defective part images are combined with the normal product images based on the defective part data, the normal product data, and generation parameters; a learning data storage unit that stores the learning data; and a generation parameter setting unit that sets the generation parameters.”

As above, in Patent Literature 1, defective part images are combined with normal product images to generate defective product images, compensating for lack of defective product images.

### CITATION LIST

### Patent Literature

Patent Literature 1: Japanese Unexamined Patent Application Publication No. 2020-027424

### SUMMARY OF INVENTION

### Technical Problem

However, the learning data generated in Patent Literature 1 is, as illustrated in paragraphs 0047 to 0048, FIG. 6, etc. in the same literature, a pseudo defective product image in which a largeness, angle, color, brightness of a defective part image are changed to be combined with the same positions on normal product images. Therefore, the pseudo defective product image generable in Patent Literature 1 is limited to a pseudo defective product image of a processed product having the same specification as an actually taken defective product image, and a pseudo defective product image for a processed product having a different specification is difficult to generate. In addition, in Patent Literature 1, it is difficult to generate a pseudo defective product image having a defective part at a different position from an actually taken defective product image even when processed products have the same specification.

Therefore, in Patent Literature 1, when many pseudo product images for processed products having multiple specifications are to be respectively generated, a defective part image needs to be prepared for each specification of a processed product or for each position of a defective part. This requires considerable effort for preparation work before generation of learning data.

For addressing this problem, an object of the present invention is to provide a pseudo defect image generation device in which, by using common defective part images when pseudo defective product images for multiple processed products having different specifications are generated, various pseudo defective product images can be easily generated.

### Solution to Problem

To solve the above subject, a pseudo defect image generation device of the present invention is a pseudo defect image generation device that generates a pseudo defect image to be learned by a learning device. The device includes: a defect library storing defective part images; a defect arrangement rule that specifies, based on management information that associates a processing item and permissible processing content with each other, a defect corresponding to the processing item and an inspection region; and a pseudo defect image generation unit that generates a pseudo defect image by arranging the defective part image onto the inspection region on a normal product image based on the defect arrangement rule.

### Advantageous Effects of Invention

According to a pseudo defect image generation device of the present invention, when pseudo defective product images for multiple processed products having different specifications are generated, common defective part images are used to enable easy generation of various pseudo defective product images.

### BRIEF DESCRIPTION OF DRAWINGS

FIG. 1 is a schematic diagram of a visual inspection system.

FIG. 2 illustrates a schematic diagram of a pseudo defect image generation device of First Embodiment.

FIG. 3 is a flowchart of pseudo defect image generation processing.

FIG. 4A illustrates an example of a GUI of a setting unit of First Embodiment.

FIG. 4B illustrates an example of a GUI of a setting unit of First Embodiment.

FIG. 4C illustrates an example of a GUI of a setting unit of First Embodiment.

FIG. 4D illustrates an example of a GUI of a setting unit of First Embodiment.

FIG. 5 illustrates a schematic diagram of a pseudo defect image generation device of Second Embodiment.

FIG. 6 illustrates an arrangement of defects of Second Embodiment.

FIG. 7 illustrates a normal product image of Third Embodiment.

FIG. 8 illustrates a schematic diagram of a pseudo defect image generation device of Fourth Embodiment.

FIG. 9 illustrates a schematic diagram of a pseudo defect image generation device of Fifth Embodiment.

FIG. 10 illustrates a normal product image of Fifth Embodiment.

### DESCRIPTION OF EMBODIMENTS

Hereinafter, in reference to the drawings, embodiments of a pseudo defect image generation device is explained.

### First Embodiment

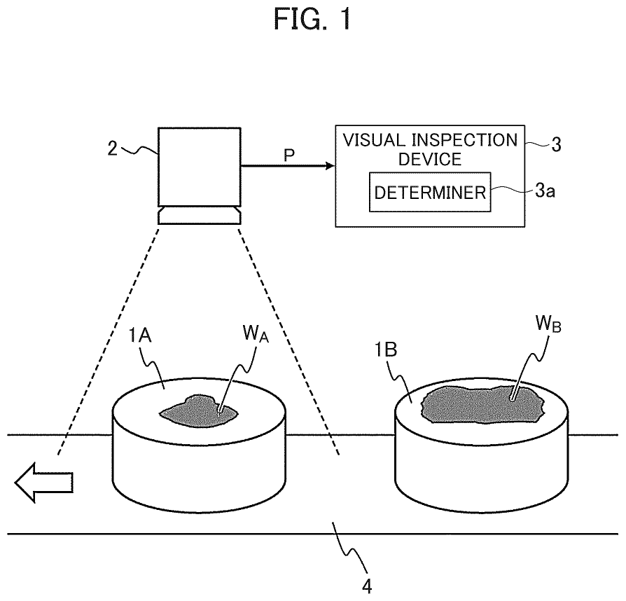

First, a pseudo defect image generation device 10 of First Embodiment of the present invention is explained using FIGS. 1 to 4D.

FIG. 1 is a schematic diagram of a visual inspection system that inspects an appearance of a processed product 1. As illustrated in the figure, this visual inspection system includes a camera 2 that takes the processed product 1, a visual inspection device 3 that visually inspects the processed product 1 based on an image P imaged by the camera 2, and a transport device 4 that transports the processed product 1 into an imaging range of the camera 2. Note that, in FIG. 1, two types of processed products 1A, 1B having different specifications are illustrated as inspection targets, but the processed products 1 to be inspected may include three or more types.

A determiner 3a generated by a learning device 20 is incorporated in the visual inspection device 3. The learning device 20 is a device that generates the determiner 3a by use of machine learning such as Deep Neural Network or Support Vector Machine to target pseudo defect images supplied from the after-mentioned pseudo defect image generation device 10 in addition to normal product images and defective product images that are actually imaged. The generated determiner 3a can visually inspect any of the processed products 1 having different specifications produced through the same processing procedure, and sequentially determine whether the processed products 1 having various specifications sequentially transported by the transport device 4 are normal products.

For example, when inspection of the determiner 3a is targeted at engine pistons (processed products 1A, 1B) being both produced through a casting process and a crown cutting process and having different specifications and at defects (cavity, scratch, or bruise) of metal processing parts WA, WB of the respective crowned surfaces of the pistons, the learning device 20 performs machine learning for a normal product image and defective product image of the metal processing parts W by each specification. Thus, the determiner 3a that can visually inspect any of the processed products 1 is generated.

Hereinafter, the pseudo defect image generation device 10 in which various defective product images supplied to the learning device 20 can be easily generated is explained in detail.

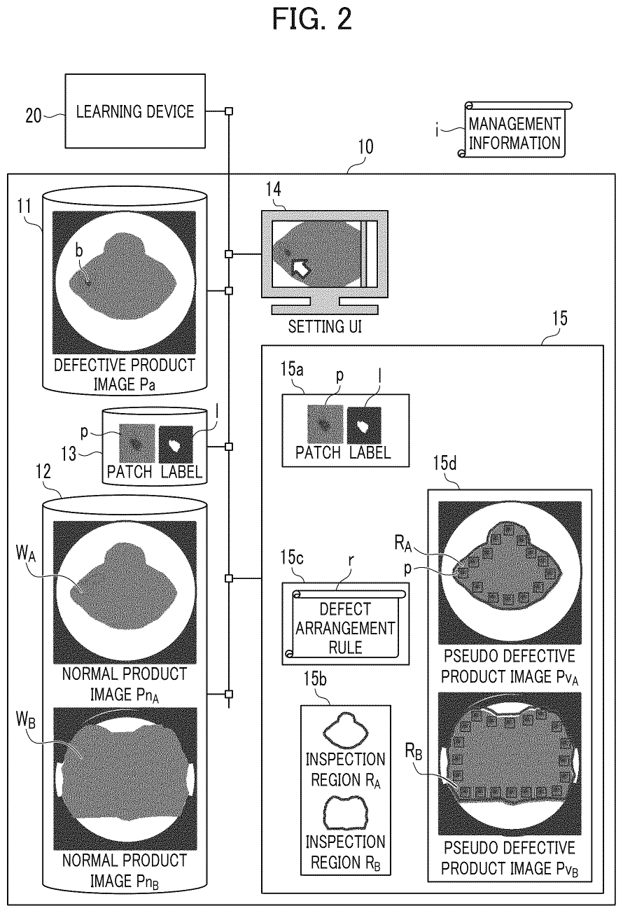

FIG. 2 is a schematic diagram illustrating the pseudo defect image generation device 10 of First Embodiment. As illustrated herein, the pseudo defect image generation device 10 of the present embodiment includes a defective product image library 11, a normal product image library 12, a defect library 13, a setting user interface (hereafter called a “setting UI 14”), and a pseudo image generation unit 15, to generate a pseudo defective product image in response to a setting input from the setting UI 14 and outputs the generated image to the learning device 20. Note that, specifically, this pseudo defect image generation device 10 is a computer including an arithmetic unit such as a CPU, a main storage device such as a semiconductor memory, an auxiliary storage unit such as a hard disk, and hardware such as a communication device. Then, the arithmetic unit executes a program read to the main storage device and the auxiliary storage stores predetermined data to achieve each after-mentioned function. Hereinafter, while explanation of such well known techniques are appropriately omitted, each portion is explained in detail.

The defective product image library 11 is a storage unit that accumulates defective product images Pa of the processed products 1 (for example, the processed product 1A) with at least one specification. Note that the defective product image Pa is an image including an after-mentioned defective part blob b. The normal product image library 12 is a storage unit that accumulates normal product images Pn (for example, normal product images Pn_{A}, Pn_{B}) of the processed products 1 (for example, the processed products 1A, 1B) with at least two specifications. The defect library 13 is a storage unit that accumulates at least one pair of a defect label l and a defect patch p extracted from the defective product image Pa. Note that the defect label l and defect patch p are after-mentioned in detail.

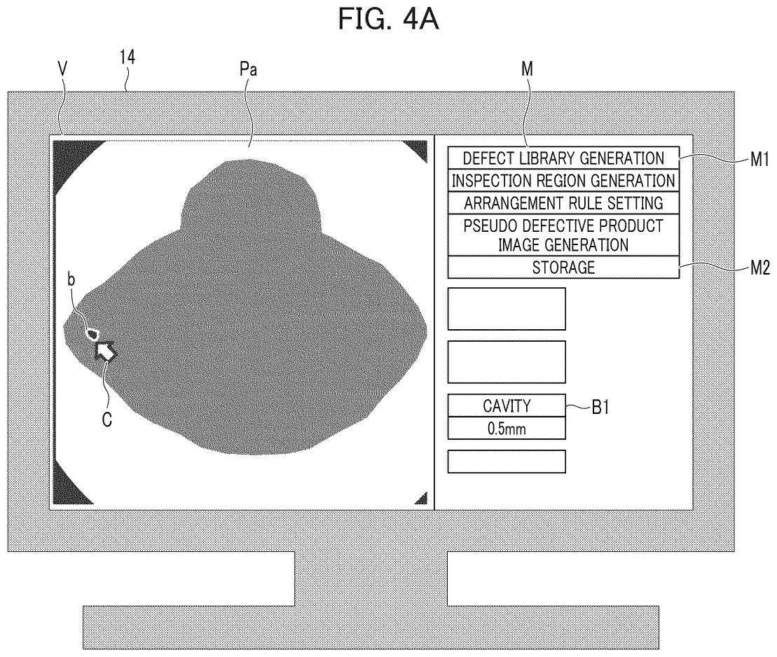

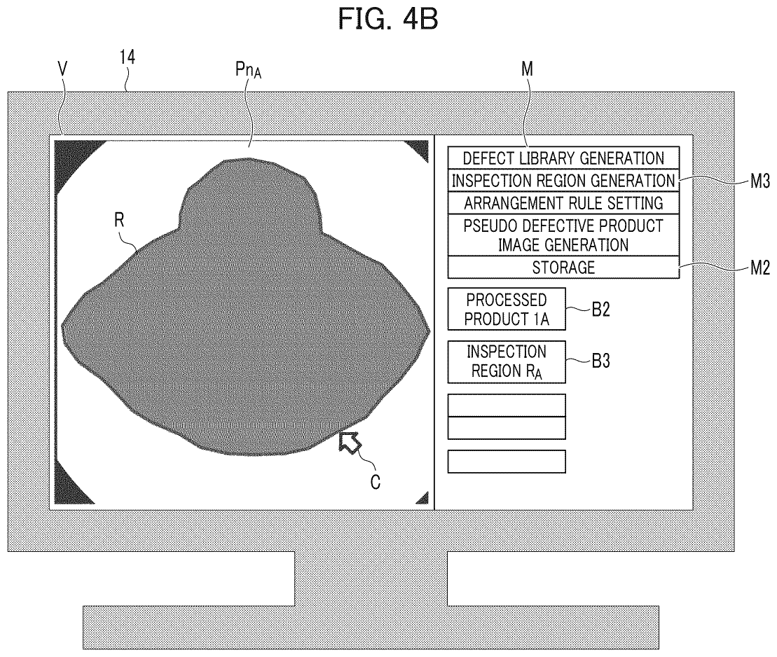

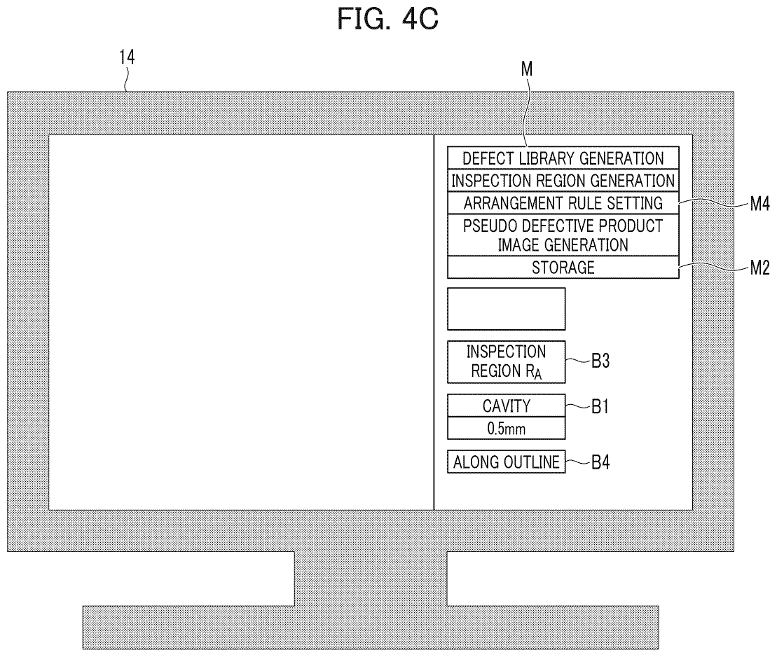

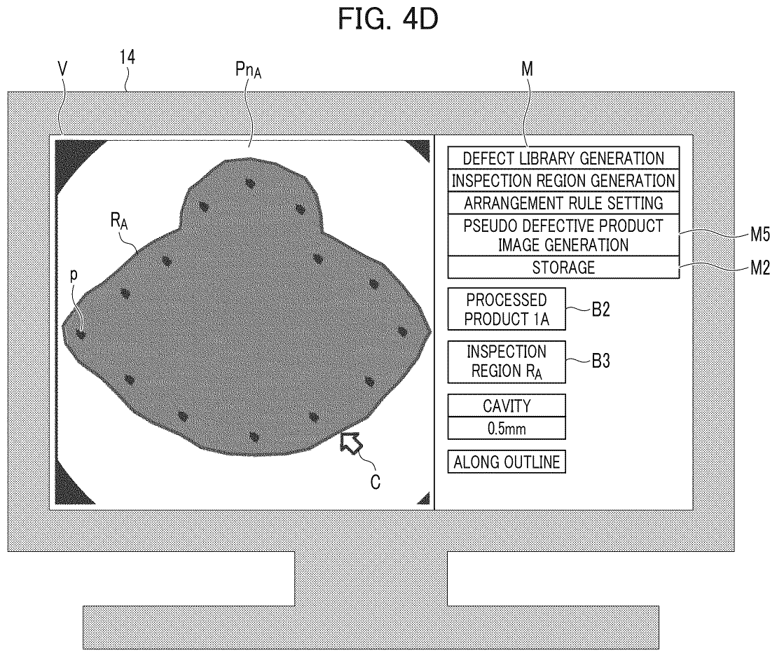

The setting UI 14 is a user interface used by a user to set and input the defect label l and an inspection region R and generate a pseudo defective product image, and specifically is a display device such as a display and an input device such as a keyboard, mouse, or touch panel. Note that the setting UI 14 is after-mentioned using FIG. 4A and FIG. 4D in detail.

The pseudo image generation unit 15 includes a defect library generation portion 15a, an inspection region generation portion 15b, a defect arrangement rule generation portion 15c, and a pseudo defective product image generation portion 15d.

The defect library generation portion 15a is mainly a functional portion that generates the defect label l and the defect patch p from the defective product image Pa. Therefore, first, the defect library generation portion 15a acquires the defective product image Pa from the defective product image library 11, and displays the image on the display of the setting UI 14. After that, when the user arbitrarily specifies the defective part blob b on the defective product image Pa displayed on the display, the defect library generation portion 15a stores a position and shape of the defective part blob b in the defect library 13 as the defect label l. Additionally, the defect library generation portion 15a cuts out the same part as the defect label 1 from the defective product image Pa, and stores the part in the defect library 13 as the defect patch p. Further, the defect library generation portion 15a stores also the defect type etc. of the defective part blob b registered by the user into the defect library 13.

In the example of FIG. 2, the defective part blob b of the defective product image Pa is a cavity, and the defect label l that is information to identify the position and shape of the cavity and the defect patch p that is image data near the cavity are stored into the defect library 13 as a pair of data. In general, when the processing procedures of the processed products 1 are the same, the appearance of the defect does not depend on the specification. Thus, the defect library generated herein can be shared by the processed product 1 that is produced through the same processing procedure and that has a different specification (for example, the processed product 1B).

The inspection region generation portion 15b is a functional portion that generates the inspection region R on the normal product image Pn. For example, when an inspection region R_{A} is generated in response to a normal product image Pn_{A} of the processed product 1A, the inspection region generation portion 15b first acquires the normal product image Pn_{A} from the normal product image library 12, and displays the image on the display of the setting UI 14. When the user traces an outer periphery of an inspection target region on the displayed image (for example, the outline of a metal processing part W_{A}) by using a mouse cursor, the inspection region generation portion 15b holds the outline data traced using the mouse cursor as the inspection region R_{A}.

When the specifications of the processed products 1 that are inspection targets are different from each other, the shapes and sizes of the products are different from each other. Thus, the inspection region R needs to be generated for each specification. Therefore, the inspection region generation portion 15b holds an inspection region R_{B} corresponding to a normal product image Pn_{B} of the processed product 1B through the above same procedure.

Note that multiple inspection regions R may be generated for one processed product 1. For example, a casting surface part and metal processing part of a crowned surface of an engine piston are set as different inspection regions, and an inside of a metal processing part may be divided into multiple inspection regions in response to the importance.

The defect arrangement rule generation portion 15c is a functional portion that generates a defect arrangement rule r based on, e.g., management information i prepared in advance. The management information i describes a management item (inspection region R, defect type) for each inspection process and a permissible content (specification of a defect size) that are associated with each other. The defect arrangement rule generation portion 15c holds an inspection region type, defect type, defect size, and arrangement method specified by the user based on the management information i on the setting UI 14 as the defect arrangement rule r.

With respect to the in inspection region R, the inspection region type corresponding to the inspection region R described in the management information i is selected and specified from the inspection region types generated in the inspection region generation portion 15b. With respect to the defect type, the defect type corresponding to the defect types described in the management information i is selected and specified from the defect types stored in the defect library 13. With respect to defect size, the defect size described in the management information i is specified. The arrangement method is selected and specified from the arrangement methods prepared in advance, such as a random arrangement, an arrangement with equal intervals, and an arrangement along the outline of the inspection region R, for each inspection region. In general, when processing procedures are the same, a generation region of a defect in a processing region is independent of a product type, the defect arrangement rule can be shared between product types.

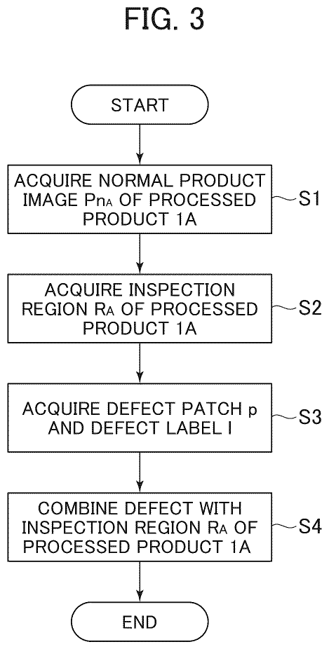

The pseudo defective product image generation portion 15d is a functional portion that generates a pseudo defective product image Pv based on the defect arrangement rule r. Hereinafter, with the flowchart of FIG. 3, by use of an example case where a pseudo defective product image Pv_{A} of the processed product 1A, pseudo defective product image generation processing is explained in detail.

First, at Step S1, the pseudo defective product image generation portion 15d acquires the normal product image Pn_{A} of the processed product 1A from the normal product image library 12.

Next, at Step S2, the pseudo defective product image generation portion 15d acquires the data of the inspection region R_{A} of the normal product image Pn_{A} corresponding to the inspection region R specified by the defect arrangement rule r from the inspection region generation portion 15b.

At step S3, the pseudo defective product image generation portion 15d acquires the defect patch p and defect label l corresponding to the defect type and defect size specified by the defect arrangement rule r from the defect library 13. Specifically, the defect patch p and defect label l having the same defect type as the defect type specified by the defect arrangement rule r and having a largeness equal to or more than the defect size specified by the defect arrangement rule r are acquired. This is to cause the determiner 3a to learn based on the pseudo defective product image Pv in which only the defect patch p having the specified size or more is arranged.

At Step S4, the pseudo defective product image generation portion 15d cuts out a part corresponding to the defect label l from the defect patch p, and combines the part with the inspection region R_{A} on the normal product image Pn_{A} in accordance with the arrangement method specified by the defect arrangement rule r to generate the pseudo defective product image Pv_{A}. For example, when an arrangement along the outline of the inspection region R is specified in the defect arrangement rule r as an arrangement method, the defect patches p are arranged along the outline of the inspection region R_{A} as illustrated in the pseudo defective product image Pv_{A} of FIG. 2. Additionally, a pseudo defect label image in which the defect labels are arranged to the same positions as the defect patches p of the pseudo defective product image Pv_{A} is generated, which is not illustrated.

On the other hand, also when a pseudo defective product image PVB of the processed product 1B having a different specification of the metal processing part W from that of the processed product 1A, the same process as FIG. 3 allows the pseudo defective product image Pv_{B} in which the defect patches p are arranged along the inspection region R_{B} to be generated. The defect patch p and defect label l used for generation of the pseudo defective product image Pv_{B} are shared. Thus, even when the defective product image of the processed product 1B cannot be provided, the pseudo defective product image Pv_{B} is generable as long as the defective product image of the processed product 1A can be provided.

### Example of GUI of Setting UI 14

Next, by use of FIG. 4A to FIG. 4D, a specific example of a GUI (Graphical User Interface) of the setting UI 14 is explained.

FIG. 4A illustrates the GUI when the defect library is generated. As illustrated herein, the processes executable in the pseudo defect image generation device 10 are listed in a processing menu M of the display of the setting UI 14. The user can select a desired one from the processes.

For example, when the user selects a defect library generation M1, the defect library generation portion 15a acquires the defective product image Pa from the defective product image library 11, and displays the image on an image display region V. When the user traces a defect region in the defective product image Pa by use of a mouse cursor C, the traced region is displayed as the defective part blob b. Additionally, the user inputs a defect type (for example, cavity) and a defect size (for example, 0.5 mm) of the defective part blob b into a defect type setting region B1. After that, when the user selects a storage M2 from the processing menu M, the defect library generation portion 15a stores the defective part blob b into the defect library 13 as the defect label l. The same part as the defect label l that is cut out of the defective product image Pa is the defect patch p, which is stored to the defect library 13 together with a defect type (for example, cavity) specified by the user.

FIG. 4B illustrates the GUI when the inspection region R is generated. As illustrated herein, a name of a product type to be inspected can be input to a product type setting region B2. When the user inputs a product type (the processed product 1A is inputted in the figure) after selecting an inspection region generation M3 from the processing menu M, the inspection region generation portion 15b acquires the normal product image Pn_{A} of the processed product 1A from the normal product image library 12, and displays the acquired image on the image display region V. Then, the region traced by the user with the mouse cursor C is displayed as the inspection region R. Additionally, an inspection region name can be inputted to an inspection region type input region B3. When the user inputs the inspection region type (the inspection region R_{A} is inputted in the figure), and selects the storage M2 from the processing menu M, the inspection region generation portion 15b holds the inspection region R as the inspection region R_{A} of the processed product 1A.

FIG. 4C illustrates the GUI when defect arrangement rule r is generated. An arrangement method for a defect onto the pseudo defective product image Pv can be inputted into an arrangement rule setting region B4. After the user selects an arrangement rule setting M4 from the processing menu M, the inspection region type, defect type, defect size, and arrangement method (the inspection region R_{A}, cavity, 0.5 mm, and arrangement along outline of inspection region are inputted in the figure in order). Further, the storage M2 is selected from the processing menu M, the defect arrangement rule generation portion 15c holds, as a set, the inspection region type, defect type, defect size, and arrangement method specified by the user as the defect arrangement rule r.

FIG. 4D illustrates a GUI when the pseudo defective product image Pv is generated. When the user selects a pseudo defective product image generation M5 from the processing menu M and inputs a product type and inspection region type (the processed product 1A, inspection region R_{A} in the figure), the pseudo defective product image generation portion 15d acquires the normal product image Pn_{A} of the processed product 1A from the normal product image library 12, and displays the acquired image on the image display region V. Further, the inspection region R_{A} is acquired from the inspection region generation portion 15b, and overwritten and displayed on the image display region V. Further, the defect patch p and defect label l corresponding to the specified defect type and defect size are acquired from the defect library 13, and overwritten and displayed on the image display V with the specified arrangement method (along the outline in the figure). When the user selects the storage M2, the pseudo defective product image generation portion 15d holds the displayed image as the pseudo defective product image Pv. Note that this processing is equivalent to the processing explained in the flowchart of FIG. 3.

The present invention explained above can provide the pseudo defect image generation device in which the patch and label of the defective part can be shared between the product types to achieve reduction of the effort of collecting the image of the defective part for each product type. Additionally, the pseudo defect image generation device can be provided in which the defect arrangement rule when the defect is arranged in the inspection region can be shared between the product types, and the effort of specifying the defect arrangement for each product type can be reduced. Additionally, the pseudo defect image generation device can be provided in which the defect size and defect interval can be determined in response to the setting of the image region size and processing density in learning and evaluation of the learning device, and the pseudo defect image subjected to the defect arrangement with high learning efficiency is generated.

### Second Embodiment

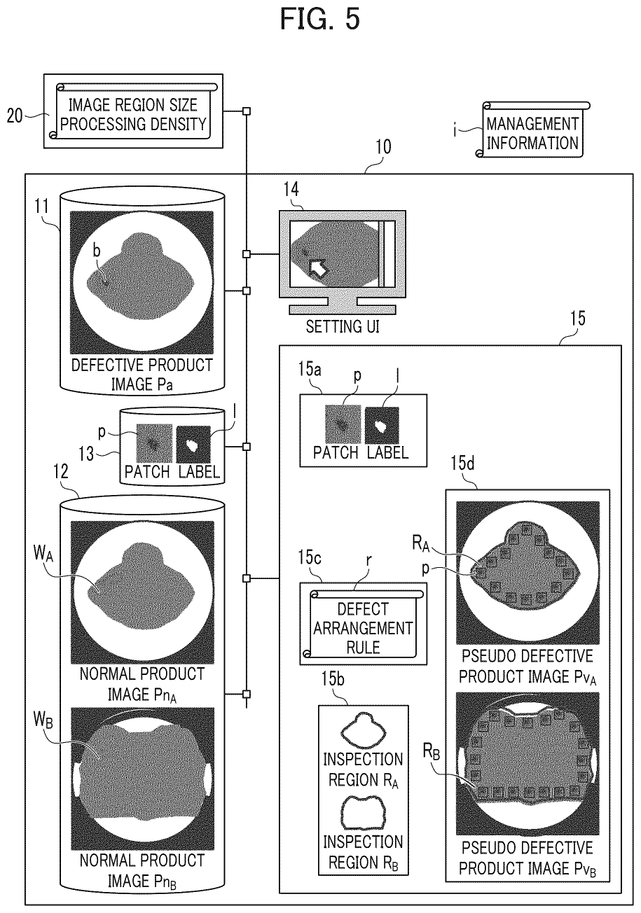

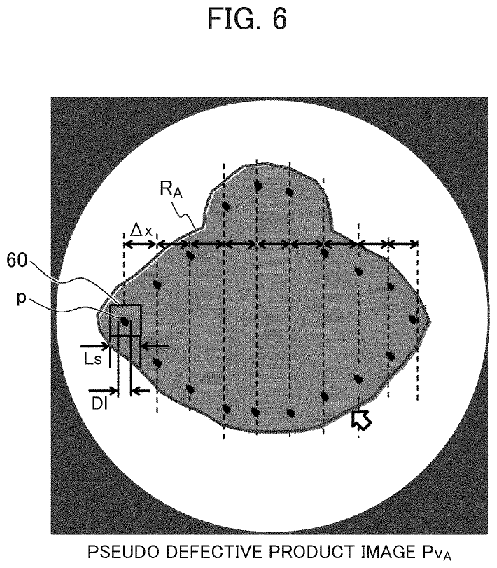

Next, Second Embodiment of the present invention is explained using FIG. 5 and FIG. 6. The common points to the above embodiment are not explained repeatedly.

In First Embodiment, the pseudo defective product image Pv is generated while the specification of the learning device 20 is not especially considered. In the pseudo defect image generation device 10 of the present embodiment, the pseudo defective product image Pv is generated in consideration of the specification of the learning device 20. To determine the existence of a defective part by the machine learning in the learning device 20 and further to output the defective part together with the position of the defect, it is preferable that an input image is divided into small rectangle regions, the existence of a defective part in each divided rectangle region is determined, and the position corresponding to the rectangle region having a defect is thus set as the position of the defect, for example.

Therefore, in the learning device 20 of the present embodiment, the image region size and processing density in learning and evaluation are set as a specification. The image region size is a size of the above rectangle region. Additionally, the processing density means a degree of an overlap in division into rectangle regions. For example, the processing density of 1 means that there is no overlap between the rectangle regions, the processing density of 2 means the overlap between the rectangle regions by a half, and the processing density of 3 means the overlap between the rectangle regions by two thirds.

Also in the present embodiment, the operation of the pseudo defective product image generation portion 15d is basically the same as First Embodiment, but different in the following points. That is, the pseudo defective product image generation portion 15d of this Embodiment generates the pseudo defective product image Pv based also on the information (image region size, processing density) acquired from the learning device 20.

For example, when generating the pseudo defective product image Pv_{A} of the processed product 1A, the pseudo defective product image generation portion 15d of the present embodiment performs Steps S1 and S2 equivalent to those of First Embodiment.

Then, at Step S3, the defect patch p and defect label l are acquired having the same defect type as the defect type specified by the defect arrangement rule r and having a size equal to or more than the defect size specified by the defect arrangement rule r and less than an image region size Ls acquired from the learning device 20. Herein, only, e.g., the defect patch p less than the image region size Ls acquired from the learning device 20 is acquired because only the defect patch p smaller than the image region size Ls that is the specification of the learning device 20 is arranged in the pseudo defective product image Pv_{A} to avoid decrease in learning efficiency due to generation of a rectangle region having only a defective part when an input image to the learning device 20 is divided into small rectangle regions.

Next, at Step S4, a part corresponding to the defect label l is cut out of the defect patch p and arranged in the inspection region R_{A} on the normal product image Pn_{A} in accordance with the arrangement method specified by the defect arrangement rule r to make the defect interval Δx satisfy the following two equations from the image region size Ls, processing density Ld, and defect label size Dl acquired from the learning device 20. Then, the pseudo defective product image Pv_{A} is generated.

$$Ls + Dl \leq Δ x$$

This is to avoid decrease in learning efficiency due to arrangement of two or more defect patches in the image region by arranging one or less defect patch p in a rectangle region 60.

$$Δ x < Ls + D 1 + Ls / Ld$$

This is to avoid decrease in learning efficiency due to arrangement of no defect patch in the image region size Ls by arranging one or more defect patch in the image region size Ls. Note that FIG. 6 illustrates the defect arrangement in the lateral direction. The defect arrangement in the longitudinal direction is the same as in the lateral direction.

According to the present embodiment, the pseudo defect image generation device can be provided in which the defect size and defect interval can be determined in response to the setting of the image region size and processing density at the learning and evaluation of the learning device to generate the pseudo defect image subjected to the defect arrangement with the high learning efficiency.

### Third Embodiment

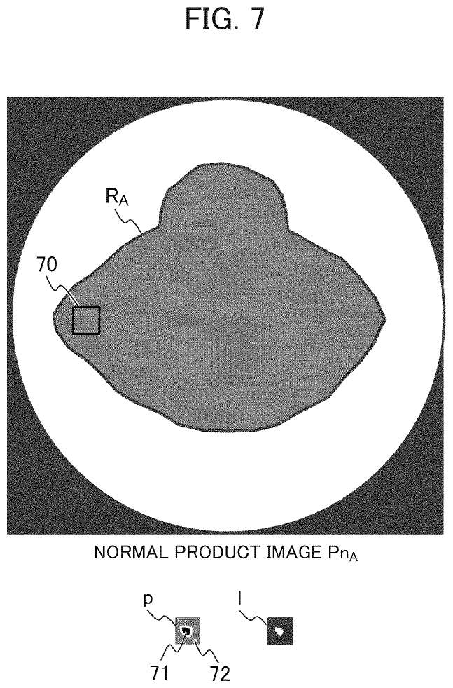

Next, Third Embodiment of the present invention is explained using FIG. 7. The common points to the above embodiment are not explained repeatedly.

For example, according to the present embodiment, when the pseudo defective product Pv_{A} of the processed product 1A is generated, the pseudo defective product image generation portion 15d of the present embodiment first performs Steps S1, S2, and S3 equivalent to those of First Embodiment.

Then, at Step S4, a part corresponding to the defect label l is cut out of the defect patch p, and combined with the inspection region R_{A} on the normal product image Pn_{A} in accordance with the arrangement method specified by the defect arrangement rule r to generate the pseudo defective product image Pv_{A}.

At this time, a gradation value of the defect patch p is corrected and combined. For example, as illustrated in FIG. 7, a gradation value of a part 70 with which the defect patch p on the normal product image Pn_{A} is combined is Ba, a gradation value of a part 71 corresponding to the defect label l of the defect patch p is Bc, and a gradation value of a part 72 corresponding to a background not corresponding to the defect label l of the defect patch p is Bb, and a gradation value Bd is determined and combined after correction of the defect patch based on the following equation.

$$Bd = Ba \times Bc / Bb$$

According to the present embodiment, the pseudo defect image generation device can be provided in which, when the gradation value of the normal product image and the gradation value of the background of the defect patch are different from each other, the pseudo defect image having natural gradation is generated.

### Fourth Embodiment

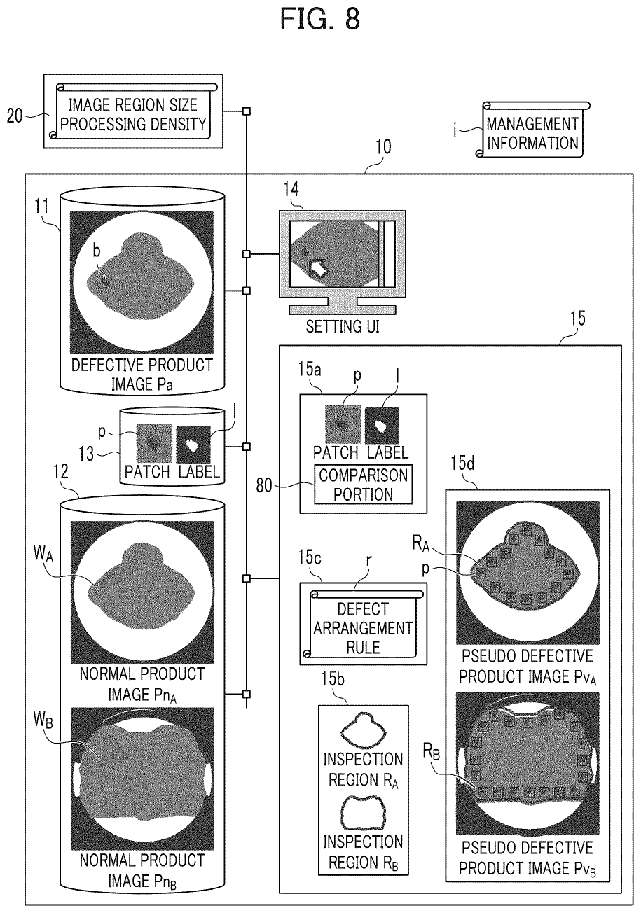

Next, Fourth Embodiment of the present invention is explained using FIG. 8. The common points to the above embodiment are not explained repeatedly.

As illustrated in FIG. 8, a normal defect comparison portion 80 is added to the defect library generation portion 15a of the present invention to generate the defect patch p and defect label 1 from the defective product image Pa with a different method from First Embodiment.

Specifically, the defect library generation portion 15a first acquires the defective product image Pa from the defective product image library 11, and acquires the normal product image Pn from the normal product image library 12. Then, the normal defect comparison portion 80 compares the two images to each other, a region having a predetermined difference or more is the defect blob b, the defective part blob b is the defect label l, the same part as the defect label l cut out of the defective product image Pa is the defect patch p, these blob, label, and patch are stored into the defect library 13 together with the defect type specified by the user, such as a cavity.

That is, according to the present embodiment, the pseudo image generation device can be provided in which the defect library can be produced without the specification of the blob b by the user, and the effort of producing the defect library by the user can be reduced.

### Fifth Embodiment

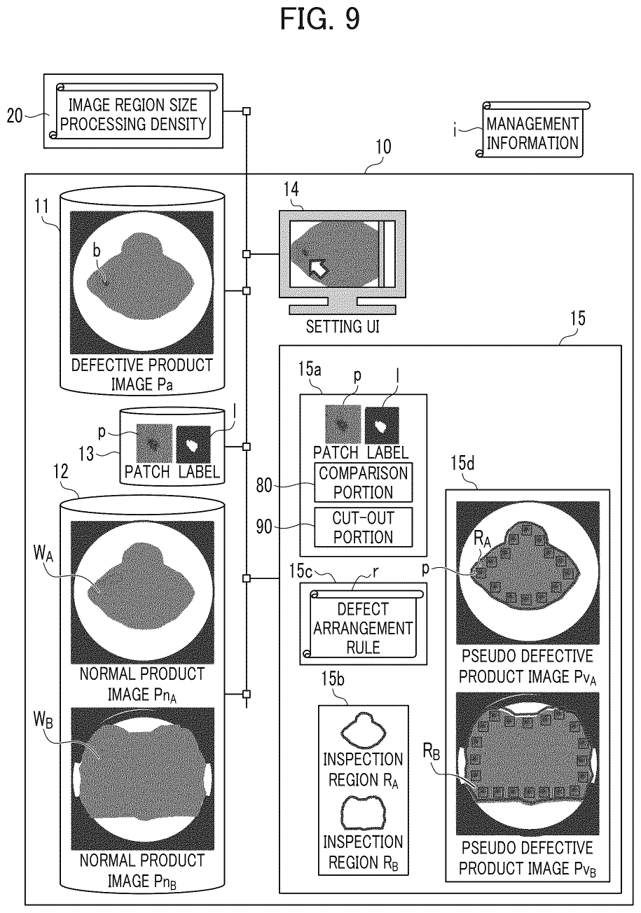

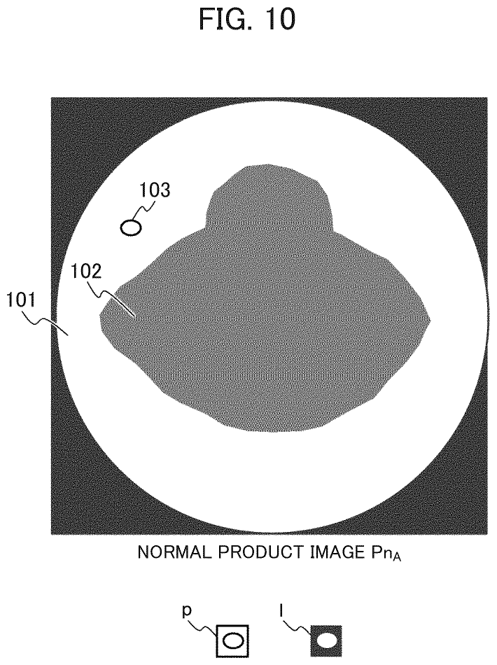

Next, Fifth Embodiment of the present invention is explained using FIG. 9 and FIG. 10. Note that the common points to Fourth Embodiment are not explained repeatedly.

As illustrated in FIG. 10, a texture cut-out portion 90 in addition to the normal defect comparison portion 80 is added to the defect library generation portion 15a of the present embodiment to generate the defect patch p and defect label l from the defective product image Pa through a different method from First and Fourth Embodiment.

Specifically, the defect library generation portion 15a first acquires the normal product image Pn from the normal product image library 12, and displays the image on the display of the setting UI 14. The processed product 1A to be inspected is subjected to some processing before inspection. For example, the processed product 1A to be inspected is a cast component, part of a surface of which is subjected to machining.

In this case, as illustrated in FIG. 10, the processed product 1A on the normal product image Pn_{A} is divided into a casting surface part 101 and machining part 102. The texture cut-out portion 90 sets, as the defect label l, the region that is specified on the displayed image by the user, for example, traced on the casting surface part 101 by use of the mouse cursor C, and that corresponds to a casting surface cut-out part 103, and sets the same part as the defect label l cut out of the normal product image Pn_{A} as the defect patch p and the label and patch are stored in the defect library 13 together with the defect type such as casting surface roughening. From this defect library, the casting surface roughening defect can be combined in reference to the defect arrangement rule and by arrangement onto the metal processing part.

According to the present embodiment, the pseudo defect image generation device can be provided in which the defective product image Pa is unnecessary, the defect library can be created from the normal product image Pn, and the effort of collecting the images of defective parts by the user can be reduced.

### Sixth Embodiment

Next, Sixth Embodiment of the present invention is explained. The common points to the above embodiment are not explained repeatedly. In the above embodiments, the defect library generation portion 15a generates the defect patch p from the defective product image Pa. For example, an image artificially generated by imitating a defective part may be used as the defect patch p. Note that the image artificially generated by imitating a defective part corresponds to a defect described by the user by using, e.g., paint software.

### LIST OF REFERENCE SIGNS

1: processed product, 2: camera, 3: visual inspection device, 3a: determiner, 4: transport device, 10: pseudo defect image generation device, 11: defective product image library, 12: normal product image library, 13: defect library, 14: setting UI, 15: pseudo image generation unit, 15a: defect library generation portion, 15b: inspection region generation portion, 15c: defect arrangement rule generation portion, 15d: pseudo defective product image generation portion, 20: learning device, Pn: normal product image, Pa: defective product image, Pv: pseudo defective product image, V: image display region, C: mouse cursor, M: processing menu, M1: defect library generation, M2: storage, M3: inspection region generation, M4: arrangement rule setting, M5: pseudo defective product image generation, B1: defect type setting region, B2: product type setting region, B3: inspection region type input region, B4: arrangement rule setting region, i: management information, r: defect arrangement rule, b: defective part blob, 1: defect label, p: patch, R: inspection region, W: metal processing part

1. A pseudo defect image generation device that generates a pseudo defect image to be learned by a learning device, the pseudo defect image generation device comprising:
a defect library that stores a defective part image;
a defect arrangement rule that specifies, based on management information in which a processing item and a permissible processing content are associated with each other, a defect and an inspection region in accordance with the processing item; and
a pseudo defect image generation unit that generates a pseudo defect image by arranging the defective part image in the inspection region on a normal product image based on the defect arrangement rule.

2. The pseudo defect image generation device according to claim 1 further comprising:
a defective product image library that stores a defective part image of a processed product with at least one specification; and
a normal product image library that stores normal product images with at least two specifications, wherein
the defective part image stored in the defect library is cut out of the defective product image, and
when generating the pseudo defect image, the pseudo defect image generation unit uses a shared defective part image when generating a pseudo defect image of a processed product with any specification.

3. The pseudo defect image generation device according to claim 1 wherein
an image region size to be learned and a processing density of learning are set in the learning device, and the pseudo defect image generation unit generates a pseudo defect image in which an arrangement interval of the defects is equal to or more than the image region size and the arrangement interval of the defects is equal to or less than the processing density.

4. The pseudo defect image generation device according to claim 1 wherein
the pseudo defect image generation unit corrects a gradation value of the defective part image in response to a gradation value of a normal product image to generate the pseudo defect image.

5. The pseudo defect image generation device according to claim 1 wherein
the pseudo defect image generation unit stores, into the defect library, a defective part image extracted by comparing a defective product image and a normal product image to each other.

6. The pseudo defect image generation device according to claim 1 wherein
the pseudo defect image generation unit stores an image in a region specified from a normal product image by a user into the defect library as a defective part image.

7. The pseudo defect image generation device according to claim 1 wherein
the defective part image is an image artificially generated by imitating an actual defect.
